(19) United States
(12) Patent Application Publication
(10) Pub. No.: US 2025/0214458 A1
(43) Pub. Date: Jul. 3, 2025

(54) MOVING BODY POWER SUPPLY SYSTEM AND MOVING BODY DEVICE

(71) Applicants: SUMIDA CORPORATION, Tokyo (JP); NATIONAL UNIVERSITY CORPORATION, IWATE UNIVERSITY, Iwate (JP)

(72) Inventors: Tsunaki KANEKO, Miyagi (JP); Masaki SAITO, Miyagi (JP); Thitaporn DETMOD, Miyagi (JP); Kenji TERAO, Miyagi (JP); Masahiro DAIBO, Morioka (JP); Asahi SATO, Morioka (JP)

(21) Appl. No.: 18/849,296

(22) PCT Filed: Apr. 3, 2023
(86) PCT No.: PCT/JP2023/013839

§ 371 Date: Sep. 20, 2024

(30) Foreign Application Priority Data
Jun. 20, 2022 (JP) 2022-099134

(51) Int. Cl. B60L 53/12; B60L 53/30; H02J 50/12; H02M 1/14; H02M 7/06

(52) U.S. Cl. CPC B60L 53/12; B60L 53/32; H02J 50/12; B60L 2200/26; B60L 2210/30; B60L 2270/147; H02M 1/14; H02M 7/06

(57) ABSTRACT

An alternating current flows in a primary conductor. A moving body device (such as a vehicle) has a vector potential coil. The vector potential coil senses a vector potential in a contactless manner generated by the alternating current flowing in the primary conductor. The vector potential coil conducts a current generated from a voltage difference due to the vector potential. Further, the primary conductor is a part or an entirety of a conductor wire that is continuously arranged along a moving path (such as a road) of the moving body device. The vector potential coil continuously senses the vector potential in the contactless manner and conducts the current when the moving body device (such as the vehicle) is on the moving path (such as the road).

### CROSS REFERENCE TO RELATED APPLICATIONS

This application is a 371 U.S. National Phase of International Application No. PCT/JP2023/013839, filed on Apr. 3, 2023, which claims priority to Japanese Patent Application No. 2022-099134, filed Jun. 20, 2022. The entire disclosures of the above applications are incorporated herein by reference.

### BACKGROUND

### Technical Field

The present invention relates to a moving body power supply system and a moving body device.

### Related Art

In one system, a plurality of primary coils are embedded in a road at predetermined intervals. A secondary coil is installed in a vehicle. Further, when the vehicle (the secondary coil) passes over the primary coil, power is supplied from the primary coil to the vehicle (the secondary coil) through electromagnetic coupling between the primary coil and the secondary coil (for instance, refer to Patent Document 1).

On the other hand, a detection device for an alternating current (AC) vector potential, which uses a vector potential coil in which a solenoid coil is wound in an annular shape, has been developed (for instance, refer to Patent Document 2). Further, a shield penetration device, which utilizes a characteristic in which a vector potential penetrates an electromagnetic shield, has been developed (for instance, refer to Patent Document 3).

### PRIOR ART DOCUMENTS

### Patent Documents

Patent Document 1: Japanese Patent Publication Number 2015-510746.
Patent Document 2: The specification of Japanese Patent Number 6950925.
Patent Document 3: International Patent Publication Number WO2015/099147.

However, in the case of the above-mentioned system, when the secondary coil is located at a position directly above the primary coil, a coupling coefficient of the electromagnetic coupling between the two is relatively high. But, when the secondary coil is shifted from the position directly above the primary coil, the coupling coefficient is rapidly lowered. Therefore, in order to supply sufficient power to the secondary coil of a vehicle passing over the primary coil, a large current should be conducted through the primary coil in a very short period of time, which not only requires costs for drive circuits to conduct the current through a plurality of primary coils but also increases the cost of the system.

The present invention has been made in consideration of the above problems. The present invention has an object that is to obtain a moving body power supply system that realizes power supply to a moving body device at relatively low cost and a moving body device that can be used with the moving body power supply system.

### SUMMARY

A moving body power supply system according to the present invention includes a primary conductor through which an alternating current (AC current) flows (or is conducted), and a moving body device equipped with a vector potential coil that senses a vector potential in a contactless manner generated by the AC current flowing through the primary conductor and conducts a current generated from a voltage difference due to the vector potential. The primary conductor is a part or all (an entirety) of a conductor wire that is continuously arranged along a moving path of the moving body device. The vector potential coil continuously senses the vector potential in the contactless manner and conducts the current when the moving body device is on the moving path.

A moving body device according to the present invention is equipped with a vector potential coil that senses a vector potential in a contactless manner generated by an alternating current that flows through a primary conductor, which is a part of all (an entirety) of a conductor wire that is continuously arranged along a moving path of the moving body device, and conducts a current generated from a voltage difference due to the vector potential. The vector potential coil continuously senses vector potential in the contactless manner and conducts the current when the moving body device is on the moving path.

### Effects of the Invention

According to the present invention, it is possible to obtain a moving body power supply system that realizes power supply to a moving body device at relatively low cost and a moving body device that can be used with the moving body power supply system.

### BRIEF DESCRIPTION OF THE DRAWINGS

FIG. 1 is a perspective view that shows an example of a moving body power supply system according to a first embodiment of the present invention.

FIG. 2 is a perspective view that explains a primary conductor and a vector potential coil in the moving body power supply system shown in FIG. 1.

FIG. 3 is a diagram that explains a change in power receiving efficiency with respect to a positional deviation of a power receiving side with respect to a power transmitting side in a verification experiment.

FIG. 4 is a block diagram that shows an example of an electrical configuration of the moving body power supply system shown in FIG. 1.

FIGS. 5A and 5B are diagrams that show an example of a plurality of primary conductors along a road having a plurality of lanes with respect to the moving body power supply system shown in FIG. 1.

FIG. 6 is a diagram that shows an example of a meandering primary conductor (a primary conductor in a meandering manner) on a road in an urban area with respect to the moving body power supply system shown in FIG. 1.

FIG. 7 is a diagram that shows an example of a primary conductor in a parking lot with respect to the moving body power supply system shown in FIG. 1.

FIG. 8 is a cross-sectional view that shows an example of an arrangement of a vector potential coil 2 in a moving body device according to a second embodiment of the present invention.

FIG. 9 is a cross-sectional view that shows another example of an arrangement of the vector potential coil 2 in the moving body device according to the second embodiment of the present invention.

FIG. 10 is a side view that shows an example of a moving body power supply system according to a third embodiment of the present invention.

FIG. 11 is a front view that shows an example of an installation position of a vector potential coil with respect to the third embodiment.

FIG. 12 is a front view that shows an example of a vector potential coil 2 and a ferromagnetic member 2A in a moving body device according to a fourth embodiment.

FIG. 13 is a front view that shows an example of a vector potential coil 2 and a ferromagnetic member 2B in a moving body device according to a fifth embodiment.

FIG. 14 is a front view that shows an example of a vector potential coil 2 in a moving body device according to a sixth embodiment.

FIG. 15 is a front view that shows an example of a vector potential coil 2 and a ferromagnetic member 2C in a moving body device according to a seventh embodiment.

FIG. 16 is a front view that shows an example of a vector potential coil 2 and a ferromagnetic member 2D in a moving body device according to an eighth embodiment.

FIG. 17 is a front view that shows an example of a vector potential coil 2 in a moving body device according to a ninth embodiment.

FIG. 18 is a top view that shows an example of a vector potential coil 2 in a moving body device according to a tenth embodiment.

FIG. 19 is a circuit diagram that explains a resonant circuit in a moving body device according to an eleventh embodiment.

FIG. 20 is a diagram that shows a simulation result of an output voltage of a power supply device 6 with respect to the eleventh embodiment.

### DETAILED DESCRIPTION

Embodiments of the present invention will be explained below with reference to the drawings.

### First Embodiment

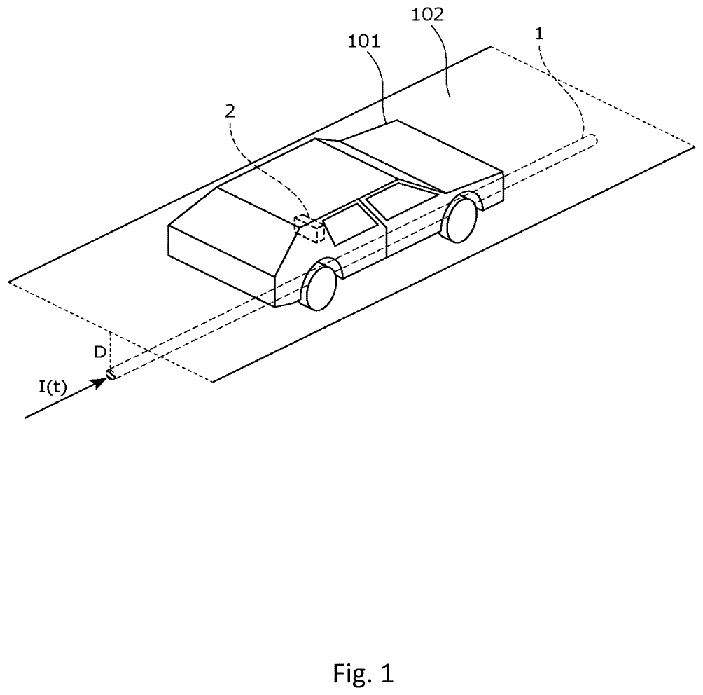

FIG. 1 is a perspective view that shows an example of a moving body power supply system according to a first embodiment of the present invention.

The moving body power supply system shown in FIG. 1 has a primary conductor 1 and a vehicle 101 that is equipped with a vector potential coil 2, and supplies power from the primary conductor 1 to the vector potential coil 2 by utilizing a vector potential.

An alternating current (AC current) is conducted (or flows) through the primary conductor 1. The vehicle 101 is a kind of a moving body device that moves on a road 102 as a moving path and is an electric vehicle in this embodiment. Further, the vector potential coil (also referred to as “a VP coil” below) 2 senses the vector potential that is generated by the AC current being conducted through the primary conductor 1 in a contactless manner and conducts a current (AC current) being induced by the vector potential. Further, in a case where the vehicle 101 is not moving and is stopped, if an AC current is conducted through the primary conductor 1, the above-mentioned AC current is induced in the VP coil 2.

The primary conductor 1 is a part or all (an entirety) of a (non-wound) conductor wire that is continuously arranged along a moving path of the moving body device (here, for instance, the road 102 on which the vehicle 101 can pass through). In the first embodiment, the primary conductor 1 is in a linear or curved shape according to the shape of the road 102. For instance, as shown in FIG. 1, the primary conductor 1 is embedded in the center of the road 102 (traffic lane) at a predetermined depth D. Further, for instance, a covered conductor wire is used for the primary conductor 1 and is insulated from the ground.

When the vehicle 101 (moving body device) is on the moving path (here, the road 102 in which the primary conductor 1 is installed), the VP coil 2 continuously senses the vector potential in a contactless manner and conducts a current.

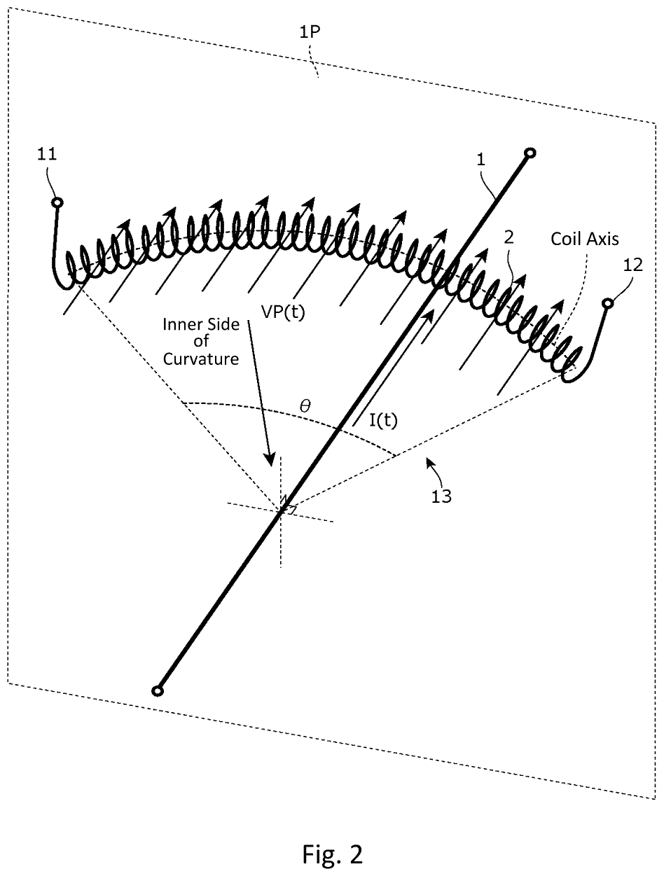

FIG. 2 is a perspective view that explains the primary conductor 1 and the vector potential coil 2 in the moving body power supply system shown in FIG. 1.

In this embodiment, for instance, as shown in FIG. 2, the VP coil 2 is a solenoid coil extending along a curved coil axis. Further, the primary conductor 1 is arranged so as to be located at an inner side (an inner direction) of the curvature of the coil axis. In addition, the VP coil 2 is arranged so that the coil axis (a winding center line of the VP coil 2) extends within a vertical plane 1P perpendicular to the primary conductor 1. Here, the coil axis is formed to be in an open curved shape and in a shape in which an angle as viewed from the primary conductor 1 at each position on the coil axis from one end to the other end of the VP coil 2 monotonously increases or decreases. Therefore, in a curvature inner side, the VP coil 2 forms an opening 13.

Further, it is preferred that the coil axis is formed to be in a circular arc shape around the primary conductor 1 as its center (i.e., the AC current being conducted through the primary conductor 1). In addition, it is preferred that the VP coil 2 is arranged so that the primary conductor 1 is arranged at the center of the curvature of the coil axis. Therefore, the curvature (a radius of the curvature) of the coil axis may be set according to the embedded depth D of the primary conductor 1 and the installation height of the VP coil 2 from the surface of the road 102. Furthermore, it is preferred that the VP coil 2 is arranged close to the AC current (i.e., the primary conductor 1), and for instance, the VP coil 2 is installed in the vehicle 101 so that the VP coil 2 is arranged in a position being equal to or less than 1 m or being equal to or less than 0.5 m from the primary conductor 1.

Further, in this embodiment, a central angle θ of the circular arc of the coil axis (the central angle of a sector having the circular arc as its outer periphery) is set to be equal to or less than 180 degrees. Since the sensed vector potential increases in proportion to the central angle θ, it is preferred that the central angle θ is larger. The central angle θ is any angle greater than 0 degrees and less than 360 degrees, and may further be (a) any angle greater than 0 degrees and equal to or less than 180 degrees, (b) any angle greater than 0 degrees and equal to or less than 90 degrees, (c) any angle greater than 0 degrees and equal to or less than 45 degrees, or (d) any angle equal to or greater than 0.5 degrees and less than 360 degrees, and further, (e) any angle equal to or greater than 0.5 degrees and equal to or less than 180 degrees, (f) any angle equal to or greater than 0.5 degrees and equal to or less than 90 degrees, (e) any angle equal to or greater than 0.5 degrees and equal to or less than 45 degrees, (f) any angle equal to or greater than 0.5 degrees and equal to or less than 25 degrees, or (g) any angle equal to or greater than 2 degrees and less than 360 degrees, further, (h) any angle equal to or greater than 2 degrees and equal to or less than 180 degrees, (i) any angle equal to or greater than 2 degrees and equal to or less than 90 degrees, (j) any angle equal to or greater than 2 degrees and equal to or less than 45 degrees, (k) any angle equal to or greater than 2 degrees and equal to or less than 25 degrees, or (l) any angle equal to or greater than 5 degrees and less than 360 degrees, further, (m) any angle equal to or greater than 5 degrees and equal to or less than 180 degrees, (n) any angle equal to or greater than 5 degrees and equal to or less than 90 degrees, (o) any angle equal to or greater than 5 degrees and equal to or less than 45 degrees, or (p) any angle equal to or greater than 5 degrees and equal to or less than 25 degrees.

Also, though an ideal curve line for the shape of the coil axis is a circular arc that is part of a circle, for convenience of manufacture and arrangement, it does not necessarily to be a circular arc and it may be in a shape of a smooth curve line. When the primary conductor 1 is arranged toward the recessed side (inner side) of the coil axis, a relatively large vector potential can be sensed.

Here, the AC current that is induced in the VP coil 2 will be explained. For instance, as shown in FIG. 2, a vector potential VP(t) is generated (in the same direction) in parallel to the direction of an AC current I(t) (i.e., the direction of the primary conductor 1). Further, an intensity of the vector potential VP(t) decreases in inverse proportion to a distance from the AC current I(t) (i.e., the primary conductor 1). A time differentiation of the vector potential VP(t) is proportional to an electric field. Further, a result of a line integral of the electric field over the path of the winding becomes an induced voltage. Therefore, in the VP coil 2, a high voltage is generated in a part close to the primary conductor 1, and a low voltage is generated in a part far from the primary conductor 1. Thus, since these voltages are in the same phase, a voltage difference between the two becomes an induced voltage. Further, when the number of windings of the VP coil 2 is increased, a voltage, which is in proportion to the number of windings, is generated. Therefore, by a temporal change (varying in time) of the vector potential VP(t) due to the AC current I(t) in the primary conductor 1, an AC current is induced in the VP coil 2.

Furthermore, as shown in the above-mentioned Patent Document 3, an induced voltage of a vector potential is not attenuated by an electromagnetic shield. Therefore, even if a body and a chassis of the vehicle 101 have magnetic shielding properties, an AC current is induced in the VP coil 2 by the temporal change of the vector potential due to the AC current in the primary conductor 1.

Here, the vector potential will be theoretically explained by using numerical formulas.

$$Φ = \int \int Bds = \int \int ∇ \times Ads = {∮}_{c} Adr \qquad [ Numerical Formula 1 ]$$

This formula is a relational expression for a magnetic flux Φ, in which B denotes a magnetic flux density and ∇×A denotes a rotation of a vector potential A. The last term comes from Stokes' theorem that allows a magnetic flux to be expressed as a vector potential.

$${V}_{2} = - \frac{d Φ}{dt} = - {∮}_{c} \frac{dA}{dt} dr = - {\int }_{0}^{θ} \frac{dA}{dt} dr - {\int }_{θ}^{2 π} \frac{dA}{dt} dr \qquad [ Numerical Formula 2 ]$$

This formula expresses Faraday's electromagnetic induction of using a magnetic flux as a vector potential. Faraday's electromagnetic induction is the phenomenon in which a voltage is generated in proportion to a temporal change in a magnetic flux inside a coil. The minus sign represents Lenz's law, which states that a voltage is generated in a direction that opposes the change in a magnetic flux. Here, when the magnetic flux is expressed as a vector potential, it becomes a contour integration using the relational expression of the above-mentioned magnetic flux ¢. Further, the contour integration is a closed line integral. However, when expressed as a vector potential, the integration path does not necessarily have to be closed, and a voltage is generated according to the length of the integration path of the line integral (in other words, it is the line integral that does not go around (does not make round) from the angle θ to the angle θ, rather than a contour integration. The voltage corresponding to that part of the integration path is given). That is, even when the integration path has the opening 13, a voltage is generated. Thus, even when there is no magnetic flux inside the coil, it is possible to induce a voltage if the vector potential is induced. Note that θ is the central angle of the circular arc that is formed by the coil axis. Thus, for instance, when θ is n, the output voltage V₂ is half that for one round.

The following formula is a theoretical formula for determining an open voltage being generated across both ends of the VP coil 2 from a current being conducted through the primary conductor 1, based on the characteristics of a geometric parameter of a vector potential converging coil and a parameter of a magnetic material. Here, the VP coil 2 is formed to be in a circular arc shape and the primary conductor 1 is located at the center of a circle that includes the circular arc.

$${V}_{2} = - j ω {μ}_{0} {μ}_{re} \frac{N R θ}{( 1 + k ) d} ( R - \sqrt{{R}^{2} - {r}^{2}} ) {I}_{0} {e}^{( j ω t )} \qquad [ Numerical Formula 3 ]$$

Here, V₂ denotes an output voltage of the VP coil 2, N denotes the number of winding layers of the VP coil 2, r denotes a radius of a winding coil of the VP coil 2, d denotes a diameter of the winding coil of the VP coil 2, R denotes a bending radius of the VP coil 2, I₀ denotes a current amplitude of the primary conductor 1, ω denotes a angular frequency of the above-mentioned AC current, μ₀ denotes a magnetic permeability of vacuum, μᵣₑ denotes an effective relative magnetic permeability of a ferromagnetic member explained below, θ denotes a circular arc angle (central angle) of the VP coil 2 (0<θ<360 [deg]), k denotes a winding gap ratio, and t denotes time.

For instance, in this formula, when N=2, r=0.1 m, d=0.002 m, R=0.5 m, I₀=100 A, ω=2π×1000 rad/s, μᵣₑ=100, θ=π/4 rad, and k=0.01, the output voltage V₂ (amplitude) of the VP coil 2 is approximately 310 V.

Further, in this formula, when N=10, r=0.1 m, d=0.002 m, R=1 m, I₀=100 A, ω=2π×50 rad/s, μᵣₑ=100, 0=n/4 rad, and k=0.01, the output voltage V₂ (amplitude) of the VP coil 2 is approximately 77 V.

Here, the result of a verification experiment on the penetration of an electromagnetic shield of the vector potential of the VP coil 2 will be explained.

The inventors conducted verification experiments using the VP coil 2 and a conventional spiral coil. Specifically, with respect to the VP coil 2, an AC current of 5 A and 20 kHz was conducted through a linear conductor part (primary conductor 1), and an electromagnetic shield was provided to the other conductor part with a steel pipe having a thickness of 2 mm. In this state, the VP coil 2 (a central angle: approximately 180 degrees) was arranged so as to be in parallel to the vertical plane of the linear conductor part, and output power of the VP coil 2 was measured with and without an iron plate having a thickness of 5 mm between the VP coil 2 and the linear conductor part. Further, with respect to the spiral coil, the spiral coil on a power transmitting side and the spiral coil on a power receiving side were arranged at positions opposed to each other, and an AC current of 5 A and 20 kHz was conducted (flowed) through the spiral coil on the power transmitting side, and output power of the spiral coil on the power receiving side was measured.

In measurements with respect to the VP coil 2, when a load resistance being connected to the VP coil 2 was changed from 10.2Ω to 50.8Ω, a power transmittance (a ratio between output power when there is no shield and output power when there is a shield) of 42.1-44.1% was confirmed. As a result, even in a state in which a magnetic flux is shielded, it was confirmed that power can be transmitted by a vector potential.

Further, in this embodiment, the vehicle 101 is composed of a member having a magnetic shielding property (for instance, steel or stainless steel), and the VP coil 2 is arranged inside the vehicle 101.

On the other hand, in measurements with respect to the spiral coil, in the case of with and without the same iron plate inserted between the coil on the power transmitting side and the coil on the power receiving side, output power of the coil on the power receiving side was measured by changing a load resistance being connected to the coil on the power receiving side from 0.15Ω to 1.00Ω. As a result, when there was the shield of the iron plate, the output power of the coil on the power receiving side was to or below the measurement limit of a measuring device being used, and the power transmittance was substantially 0%.

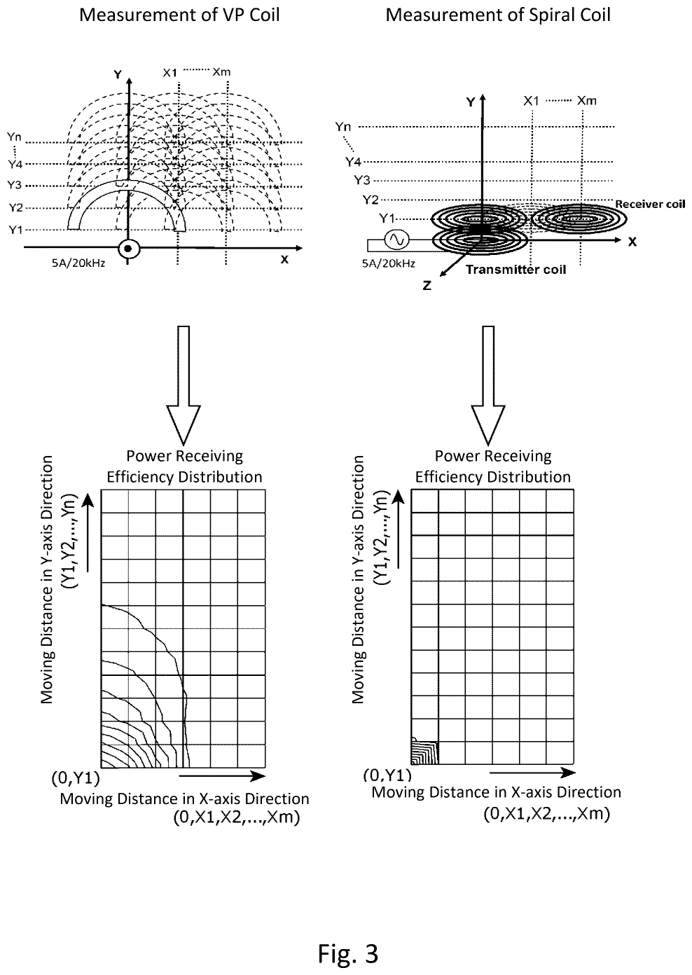

FIG. 3 is a diagram that explains a change in power receiving efficiency with respect to a positional deviation of a power receiving side with respect to a power transmitting side in a verification experiment. As shown in FIG. 3, with respect to the measurement of the change in the power receiving efficiency with respect to the positional deviation, in the measurement of the VP coil 2, a plane perpendicular to the primary conductor 1 was defined as an X-Y plane. The primary conductor 1 was arranged at an origin (0,0) of the X-Y plane along a Z axis. The VP coil 2 was arranged so that both ends of the VP coil 2 were aligned in the X-axis direction and a plane that includes the coil axis of the VP coil 2 was parallel to the X-Y plane. Further, while the primary conductor 1 was fixed, the output power of the VP coil 2 was measured when a position (Xi, Yj) of the VP coil 2 was two-dimensionally moved (i=1, . . . , m, j=2, . . . , n) in the X-axis and Y-axis directions, and the ratio of the power (power receiving efficiency) at each position (Xi, Yj) to the power at the reference point (0, Y1) was derived.

Similarly, with respect to the measurement of the spiral coil, a plane perpendicular to the winding surface of the coil on the power transmitting side was defined as an X-Y plane. The coil on the power transmitting side was arranged so that a center of the coil on the power transmitting side was arranged at an origin (0, 0) of the X-Y plane. Further, while the coil on the power transmitting side was fixed, the output power of the coil on the power receiving side was measured when a position (Xi, Yj) of the coil on the power receiving side was two-dimensionally moved (i=1, . . . , m, j=2, . . . , n) in the X-axis and Y-axis directions, and the ratio of the power (power receiving efficiency) at each position (Xi, Yj) to the power at the reference point (0, Y1) was derived.

As a result, a two-dimensional distribution of the power receiving efficiency was obtained. Further, with respect to the power receiving efficiency, the reference point (0, Y1) is set to 100%. Further, the power receiving efficiency decreases as moving away from the reference point (0, Y1). FIG. 3 represents the distribution of the power receiving efficiency with respect to the positional deviation of the VP coil 2 and the distribution of the power receiving efficiency with respect to the positional deviation of the spiral coil by contour lines. As shown in FIG. 3, with respect to the VP coil 2, the decrease in the power receiving efficiency is relatively small even when the positional deviation occurs. In other words, in the case of the VP coil 2, for instance, even if the position of the moving body in which the VP coil 2 is installed is shifted from the primary conductor 1, the power receiving efficiency does not comparatively decrease.

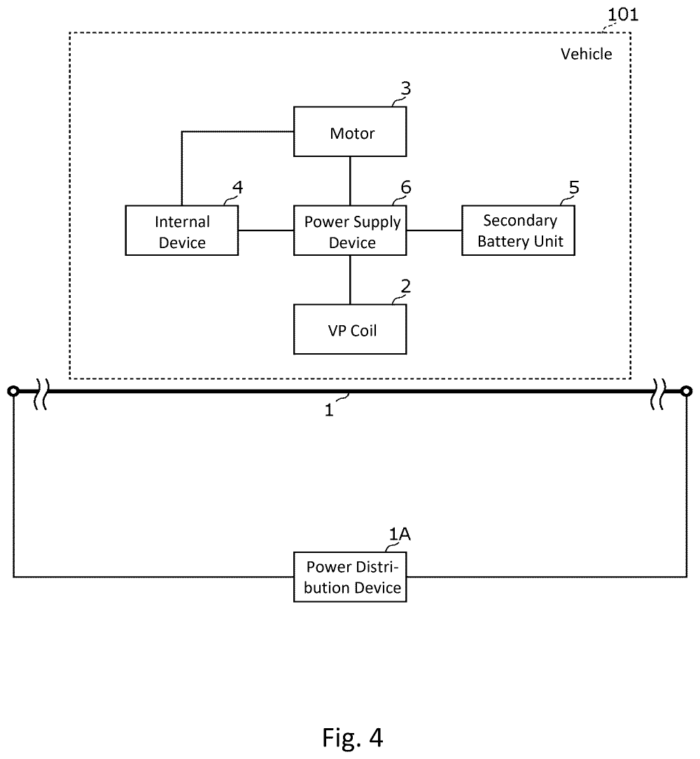

FIG. 4 is a block diagram that shows an example of an electrical configuration of the moving body power supply system shown in FIG. 1.

As shown in FIG. 4, the vehicle 101 has, in addition to the above-mentioned VP coil 2, a motor 3 for driving wheels, an internal device 4 that includes an electrical system such as a controller for the motor 3, a secondary battery unit 5, and a power supply device 6. As infrastructure, the primary conductor 1 is laid, and at the same time, a power distribution device 1A that conducts the above-mentioned AC current through the primary conductor 1 is also installed. The power distribution device 1A conducts an AC current at a predetermined frequency, and at the same time, at a predetermined amplitude. For instance, the primary conductor 1 and the power distribution device 1A may be provided for each road link or may be provided at predetermined distances.

The secondary battery unit 5 has one or a plurality of secondary battery modules that store power for driving the motor 3.

The power supply device 6 supplies power to, for instance, the motor 3, the internal device 4, and the secondary battery unit 5 based on the current being induced in the VP coil 2. The power supply device 6 may incorporate an AC/DC converter circuit and a charging circuit for the secondary battery unit 5, convert the AC power being induced in the VP coil 2 into DC power by using the AC/DC converter circuit, charge the secondary battery unit 5 based on the DC power by using the charging circuit, and supply the DC power and/or the power being stored in the secondary battery unit 5 to, for instance, the motor 3 and the internal device 4.

Further, the VP coil 2 may be one solenoid coil. Alternatively, the VP coil 2 may be a plurality of solenoid coils. In the case in which the plurality of VP coils 2 are used, as necessary, the plurality of VP coils 2 are electrically connected in series or in parallel to one another. The plurality of VP coils 2 may be aligned in the horizontal direction or in the vertical direction. In addition, the power supply device 6 may have a plurality of AC/DC converter circuits for the plurality of VP coils 2, respectively. The outputs of the plurality of AC/DC converter circuits may be connected in series or in parallel. Further, the serial or parallel outputs may be used to supply the power to the motor 3, the internal device 4, and the secondary battery unit 5.

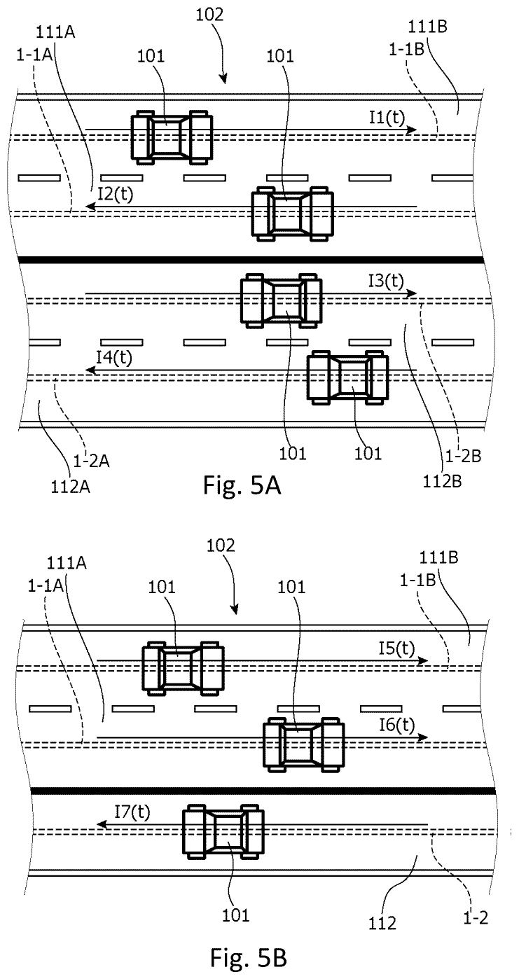

FIGS. 5A and 5B are diagrams that show an example of a plurality of primary conductors 1 along a road having a plurality of lanes with respect to the moving body power supply system shown in FIG. 1.

For instance, as shown in FIG. 5A, when the road 102 has a plurality of lanes 111A, 111B, 112A, and 112B (when the road 102 is a two-lane bidirectional road with two lanes on each side), primary conductors 1-1A, 1-1B, 1-2A, and 1-2B are arranged at the plurality of lanes 111A, 111B, 112A, and 112B, respectively. In addition, the primary conductors 1-1A, 1-1B, 1-2A, and 1-2B are arranged in parallel with one another. When the road 102 is a straight road or a curved road, any two of the primary conductors 1-1A, 1-1B, 1-2A, and 1-2B are arranged at substantially the same intervals from each other at each point. Further, some or all of the primary conductors 1-1A, 1-1B, 1-2A, and 1-2B are electrically connected in series or in parallel as necessary. Furthermore, AC currents I1(t), I2(t), I3(t), and I4(t) having the same frequency are respectively conducted through the primary conductors 1-1A, 1-1B, 1-2A, and 1-2B in the plurality of lanes 111A, 111B, 112A, and 112B in a forward direction (a predetermined direction) or a reverse direction (a direction reversing to the predetermined direction). Here, a direction and an amplitude of each of the AC currents I1(t), I2(t), I3(t), and I4(t) are set so that a difference between the sum of the AC currents I1(t) and I3(t) being conducted in the forward direction and the sum of the AC currents I2(t) and I4(t) being conducted in the reverse direction is substantially zero. As a result, since a magnetic field that is generated by the AC current being conducted in the forward direction and a magnetic field that is generated by the AC current being conducted in the reverse direction are in an opposite phase to each other, a magnetic field and EMC (Electromagnetic Compatibility) noise to an outside (such as a surrounding area) are suppressed.

Further, for instance, as shown in FIG. 5B, even when the road 102 has an odd number (three in this case) of lanes 111A, 111B, and 112 and the primary conductors 111A, 111B, and 112 are laid in parallel to one another, a direction and an amplitude of each of the AC currents I5(t), I6(t), and I7(t) of those lanes 111A, 111B, and 112 are set so that a difference between the sum of the AC currents I5(t) and I6(t) being conducted in the forward direction and the sum of the AC current I7(t) being conducted in the reverse direction is substantially zero. As a result, since the magnetic field that is generated by the AC current being conducted in the forward direction and the magnetic field that is generated by the AC current being conducted in the reverse direction are in an opposite phase to each other, the magnetic field and the EMC noise to the outside are suppressed.

Further, as mentioned above, when the road 102 has a plurality of lanes, regardless of the number of lanes on the road 102, the direction and the amplitude of each current are set so that the difference between the sum of the AC currents being conducted in the forward direction and the sum of the AC currents being conducted in the reverse direction is substantially zero. As a result, the magnetic field and the EMC noise to the outside are suppressed. Furthermore, the AC currents in two adjacent lanes may be in the same phase or in the opposite phase with each other.

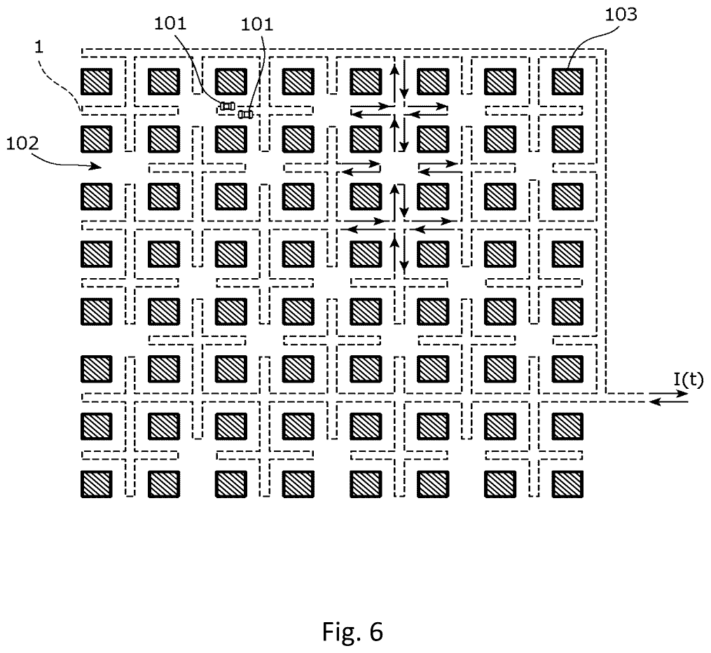

FIG. 6 is a diagram that shows an example of a meandering primary conductor 1 on a road in an urban area with respect to the moving body power supply system shown in FIG. 1.

For instance, in the urban area, the road 102 in a substantially lattice shape is arranged around a plurality of buildings 103. For instance, as shown in FIG. 6, the meandering primary conductor 1 is laid in the road 102. That is, in this case, the primary conductor 1 is in a shape that allows AC current to being conducted in a meandering manner.

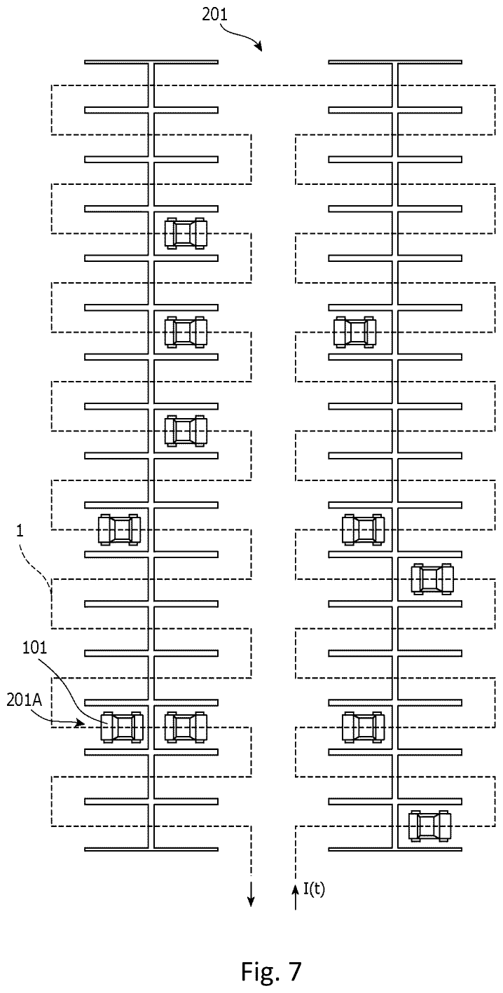

FIG. 7 is a diagram that shows an example of the primary conductor 1 in a parking lot with respect to the moving body power supply system shown in FIG. 1.

In the case in which the above-mentioned moving path includes one or a plurality of parking spaces for the vehicle 101 in a parking lot, as shown in, for instance, FIG. 7, the primary conductor 1 is laid in the parking lot 201 so as to align with an orientation of the parked vehicle (the vehicle 101 that is parked) throughout the plurality of parking spaces 201A (for instance, in the center of each of the parking spaces 201A). Thus, power is supplied to the parked vehicle 101.

Next, the operation of the moving body power supply system according to the first embodiment will be explained.

The power distribution device 1A conducts an AC current to the primary conductor 1 being laid along the moving path (for instance, the road 102 and the parking space 201A). A magnetic field and a vector potential based on the AC current are generated around the primary conductor 1 (for instance, over the road 102 and over the parking space 201A).

Then, when the vehicle 101 is located above the primary conductor 1 (while moving or stopped), a vector potential VP(t) that has a temporal change (varying in time) is generated at the installation position of the VP coil 2 due to the AC current I(t) being conducted through the primary conductor 1. Further, this time-varying vector potential VP(t) induces an AC current in the VP coil 2.

In the vehicle 101, the power supply device 6 converts AC power based on the AC current being induced in the VP coil 2 into DC power, and supplies the DC power to, for instance, the motor 3, the internal device 4, and the secondary battery unit 5. In addition, during a period of time in which sufficient power is not available from the VP coil 2 (such as when traveling through a section in which the primary conductor 1 is not laid), the power supply device 6 supplies the power being obtained from the secondary battery unit 5 to the motor 3 and the internal device 4.

As mentioned above, according to the first embodiment, the AC current is conducted through the primary conductor 1. The vehicle 101 as the moving body device has the VP coil 2. Further, the VP coil 2 senses, in the contactless manner, the vector potential being generated by the AC current that is conducted through the primary conductor 1 and conducts the current being induced by the vector potential. Furthermore, the primary conductor 1 is a part or an entirety of the conductor wire that is continuously arranged along, for instance, the road 102 and the parking space 201A that serve as the moving path of the moving body device. The VP coil 2 continuously senses the vector potential in the contactless manner and conducts the current therein when the vehicle 101 that serves as the moving body device is, for instance, on the road 102 and on the parking space 201A that serve as the moving path.

As a result, it would not be necessary to arrange a large number of primary-side coils for supplying power at predetermined intervals. It is possible to continuously supply power even while traveling by continuously laying the primary conductors 1 along the moving path. As compared with a case in which large electric power is instantaneously supplied by using the primary-side coils for supplying power, a facility scale of the primary side becomes smaller, and the power supply to the moving body device (here, the vehicle 101) can be realized at relatively low cost.

Furthermore, as compared with the case in which the large electric power is instantaneously supplied by using the primary-side coils for supplying power, since there is less change in the amplitude of the AC current being conducted in the primary side, radiation noise being caused by the power supply can be reduced.

### Second Embodiment

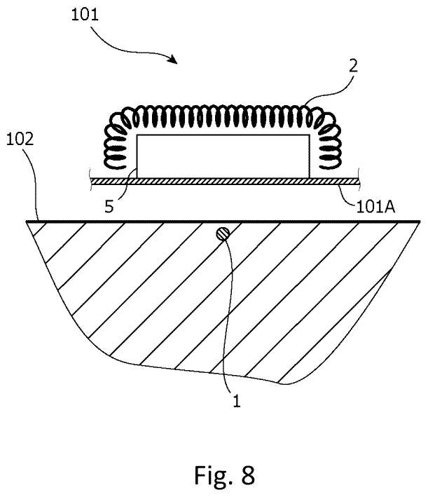

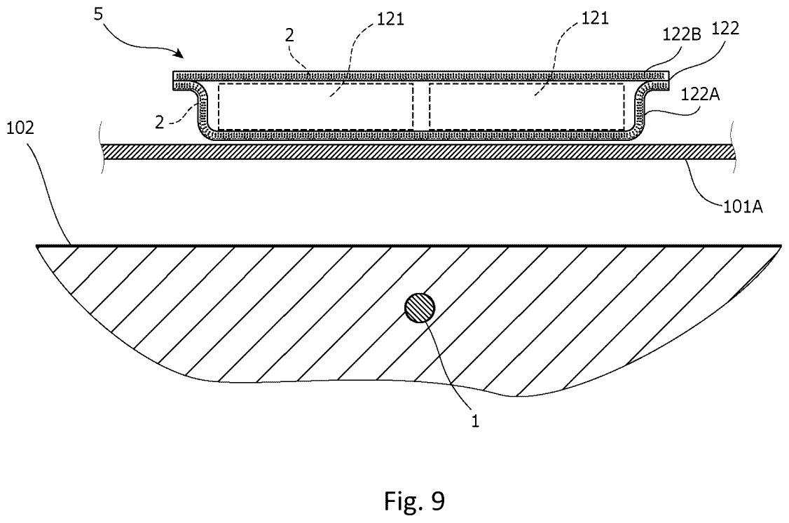

FIG. 8 is a cross-sectional view that shows an example of an arrangement of a vector potential coil 2 in a moving body device according to a second embodiment of the present invention. FIG. 9 is a cross-sectional view that shows another example of the arrangement of the vector potential coil 2 in the moving body device according to the second embodiment of the present invention.

For instance, as shown in FIGS. 8 and 9, in a vehicle 101 as the moving body device according to the second embodiment, a VP coil 2 is arranged at a chassis or body bottom 101A (a bottom 101A of a chassis or a body) of the vehicle 101 (inside the body, and above the body bottom 101A) together with a secondary battery unit 5. Since the secondary battery unit 5 being used for powering the vehicle 101 (electric vehicle) is heavy, the secondary battery unit 5 is usually installed on the chassis or body bottom 101A of the vehicle 101.

In the second embodiment, as shown in, for instance, FIG. 8, the VP coil 2 is arranged on at least an upper surface of the secondary battery unit 5 along an outer shape of the secondary battery unit 5. Here, the VP coil 2 is arranged on the upper surface and side surfaces of the secondary battery unit 5.

Further, in the second embodiment, as shown in, for instance, FIG. 9, the VP coil 2 may be arranged within a thickness of a wall of a case 122 of an electricity storage member 121 in the secondary battery unit 5. In this case, the case 122 has a lower container 122A and a lid 122B. It is arranged within the thickness of the wall of one or both of the lower container 122A and the lid 122B.

Even in the second embodiment, in the same manner as the first embodiment, the VP coil 2 is arranged so that a coil axis (a winding center line of the VP coil 2) extends within the vertical plane 1P perpendicular to the primary conductor 1.

Note that the other configurations and operations of the moving body device and the moving body power supply system according to the second embodiment are the same as those explained in the first embodiment. Therefore, the explanations of them will be omitted.

As mentioned above, according to the second embodiment, since the VP coil 2 is arranged at the chassis or body bottom 101A together with the relatively heavy secondary battery unit 5, the VP coil 2 is arranged close to the primary conductor 1. Further, by installing the power supply device 6 together with the VP coil 2 at the secondary battery unit 5, a wiring between the VP coil 2 and the power supply device 6 and a wiring between the power supply device 6 and the secondary battery unit 5 can be shortened.

### Third Embodiment

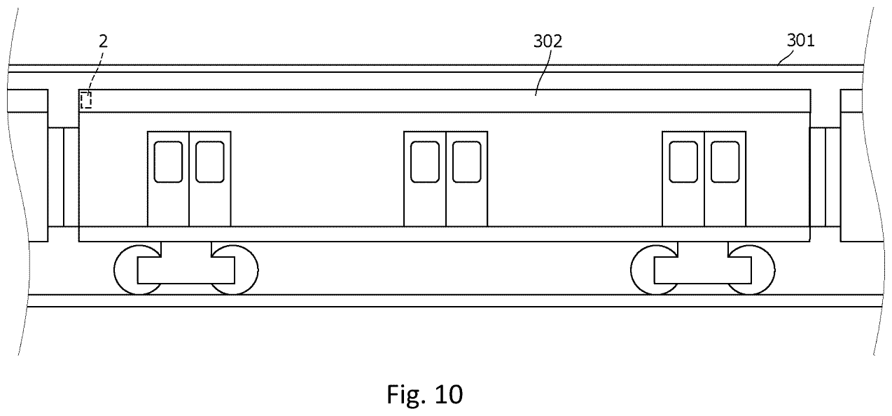

FIG. 10 is a side view that shows an example of a moving body power supply system according to a third embodiment of the present invention. In the moving body power supply system according to the third embodiment, a moving body device is a locomotive engine or a train. A moving path is a track. Further, a primary conductor is in a straight or curved shape according to a shape of the track. Here, as shown in FIG. 10, the primary conductor is an overhead wire 301 such as a trolley wire, and the moving body device is a train 302. Note that since power is supplied in a contactless manner, in the moving body power supply system according to the third embodiment, the primary conductor (the overhead wire 301) may be a covered conductor wire rather than a bare wire such as the trolley wire. Further, the train 302 has the same electrical configuration (FIG. 4) as the above-mentioned vehicle 101.

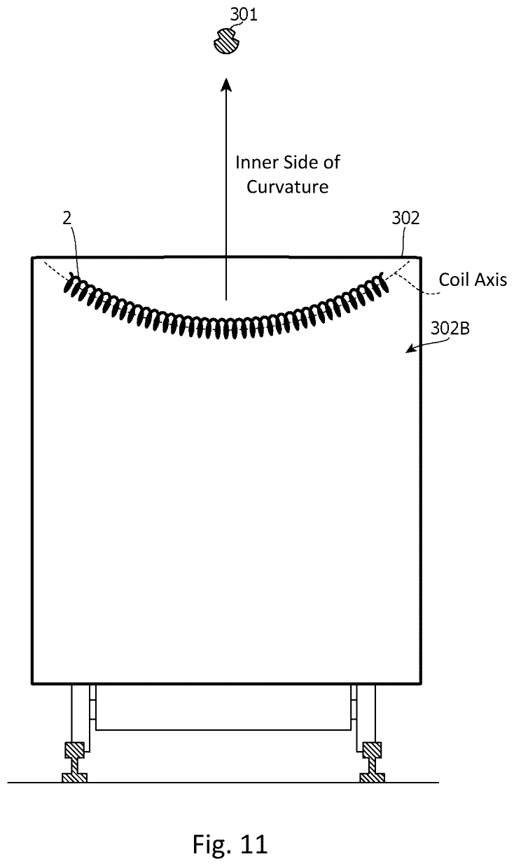

FIG. 11 is a front view that shows an example of an installation position of a vector potential coil 2 with respect to the third embodiment.

As shown in, for instance, FIG. 11, in this embodiment, the VP coil 2 is arranged at a gable (end) wall 302B of the train 302. In this embodiment, the VP coil 2 is installed at an inside of the gable wall 302B. However, the VP coil 2 may be installed at an outside of the gable wall 302B.

Furthermore, in this embodiment, the VP coil 2 is the same one as the first embodiment. As shown in, for instance, FIG. 11, the VP coil 2 is a solenoid coil extending along a curved coil axis. Further, the overhead wire 301 (the primary conductor) is arranged so as to be located at an inner side of a curvature of the coil axis. In addition, the VP coil 2 is arranged so that the coil axis (a winding center line of the VP coil 2) extends within a vertical plane perpendicular to the overhead wire 301.

Further, it is preferred that the coil axis is formed to be in a circular arc shape around overhead wire 301 as its center (i.e., the AC current being conducted through overhead wire 301), and it is preferred that the VP coil 2 is arranged so that overhead wire 301 is arranged at the center of curvature of the coil axis. Therefore, the curvature (radius of curvature) of the coil axis may be set according to the installation height of the VP coil 2. Furthermore, it is preferred that the VP coil 2 is arranged close to the AC current (i.e., the overhead wire 310, and for instance, the VP coil 2 is arranged at a position being equal to or less than 2 m or being equal to or less than 1 m from the overhead wire 301.

Note that the VP coil 2 having the curved coil axis is used here. However, one or a plurality of VP coils 2 having a straight coil axis (explained below) may be used instead. In this case, the VP coil 2 may be arranged at an outside or an inside of a roof of the train 302.

In this embodiment, a body (frame) of the train 302 may be composed of a material having a magnetic shielding property (for instance, a roof, a gable wall, or side walls, made of such as steel or stainless steel), and the VP coil 2 may be arranged within such the body.

Note that the other configurations and operations of the moving body device and the moving body power supply system according to the third embodiment are the same as those explained in the first embodiment or the second embodiment. Therefore, the explanations of them will be omitted. Further, here, the VP coil 2 is provided at the train 302. However, it is the same for the locomotive engine.

As mentioned above, according to the third embodiment, in the same manner as the first embodiment, it is only necessary to continuously lay the primary conductor 1 along the track (for instance, a path on which a rail is laid). Thus, since there is no need to arrange a large number of coils for supplying power at a primary side of the power supply, the power supply to the moving body device (such as the train 302 here) can be realized at a relatively low cost.

### Fourth Embodiment

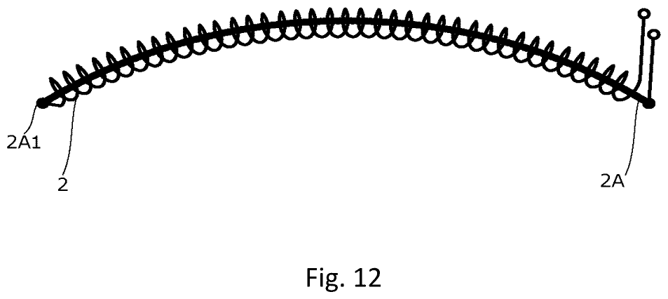

FIG. 12 is a front view that shows an example of a vector potential coil 2 and a ferromagnetic member 2A in a moving body device (for instance, the above-mentioned vehicle 101 and train 302) according to a fourth embodiment.

In the fourth embodiment, as shown in, for instance, FIG. 12, the ferromagnetic member 2A is arranged inside the VP coil 2. The ferromagnetic member 2A is in a shape along a coil axis of the VP coil 2. In addition, the ferromagnetic member 2A is a member that is made of a conductive ferromagnetic material (for instance, a metallic magnetic material such as permalloy). Further, one coil end of the VP coil 2 is electrically connected to one end 2A1 of the ferromagnetic member 2A. As a result, since two wirings, which are from the other coil end of the VP coil 2 and from the other end of the ferromagnetic member 2A adjacent to the other coil end to the power supply device 6, can be laid together, the laying of the two wirings can be simplified.

Specifically, for instance, the VP coil 2 is formed by winding a thin copper wire around a thick ferromagnetic wire serving as the ferromagnetic member 2A that is formed to be in a circular arc shape. As shown in FIG. 12, one end of the thin copper wire is electrically connected to the ferromagnetic member 2A (the one end 2A1). Further, the other end of the thin copper wire is connected to one terminal. Further, the ferromagnetic member 2A also serves as a return path for a current and is connected to the other terminal. Note that instead of the ferromagnetic member 2A, a paramagnetic member having a similar shape may be used. In the case of a ferromagnetic material, the vector potential is enhanced according to an effective magnetic permeability.

Note that the other configurations and operations of the moving body device according to the fourth embodiment are the same as those explained in any of the first to the third embodiments. Therefore, the explanations of them will be omitted.

### Fifth Embodiment

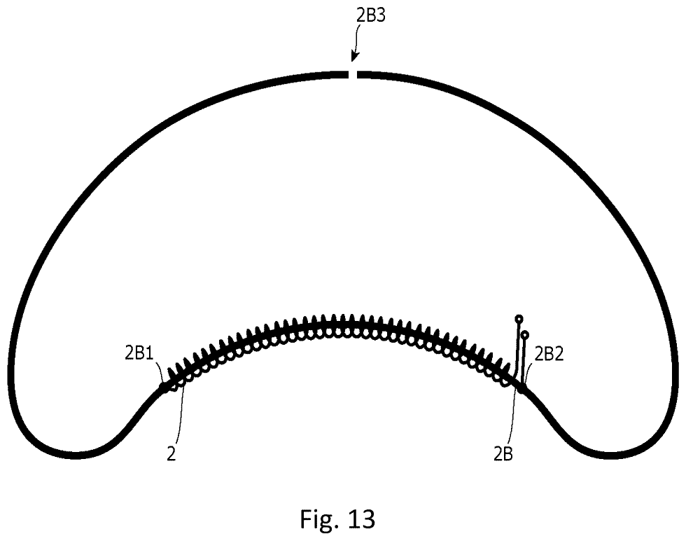

FIG. 13 is a front view that shows an example of a vector potential coil 2 and a ferromagnetic member 2B in a moving body device (for instance, the above-mentioned vehicle 101 and train 302) according to a fifth embodiment.

In the fifth embodiment, as shown in, for instance, FIG. 13, the ferromagnetic member 2B is arranged inside the VP coil 2. The ferromagnetic member 2B is in a shape along a coil axis of the VP coil 2. In addition, the ferromagnetic member 2B extends toward an outside of a curvature of the VP coil 2 (a coil axis portion of the VP coil 2) so as to form a closed magnetic path.

The ferromagnetic member 2B is a member that is made of a conductive ferromagnetic material (for instance, a metallic magnetic material such as permalloy). Further, one coil end of the VP coil 2 is electrically connected to the ferromagnetic member 2B at a connection point 2B1 on a side of the one coil end of the VP coil 2.

In addition, a lead wire is electrically connected at a connection point 2B2 on a side of the other coil end of the VP coil 2. Further, since two wirings, which are from the other coil end of the VP coil 2 and from the lead wire to the power supply device 6, can be laid together, the laying of the two wirings can be simplified.

In addition, a gap 2B3 is formed in the ferromagnetic member 2B at an outer side of the curvature of the VP coil 2. Thus, with respect to the ferromagnetic member 2B, the gap 2B3 prevents a current from being conducted through an outside part of the curvature of the VP coil 2.

Further, it is preferred that a transition portion between the inner portion and the outer portion of the ferromagnetic member 2B is made into a continuous and smooth curve shape without any steep bend portions, in order to reduce a leakage of a magnetic flux and reduce the influence of the decrease of the magnetic permeability due to bending processing. Moreover, the ferromagnetic member 2B may be formed by connecting a plurality of members.

Note that the other configurations and operations of the moving body device according to the fifth embodiment are the same as those explained in the fourth embodiment. Therefore, the explanations of them will be omitted.

### Sixth Embodiment

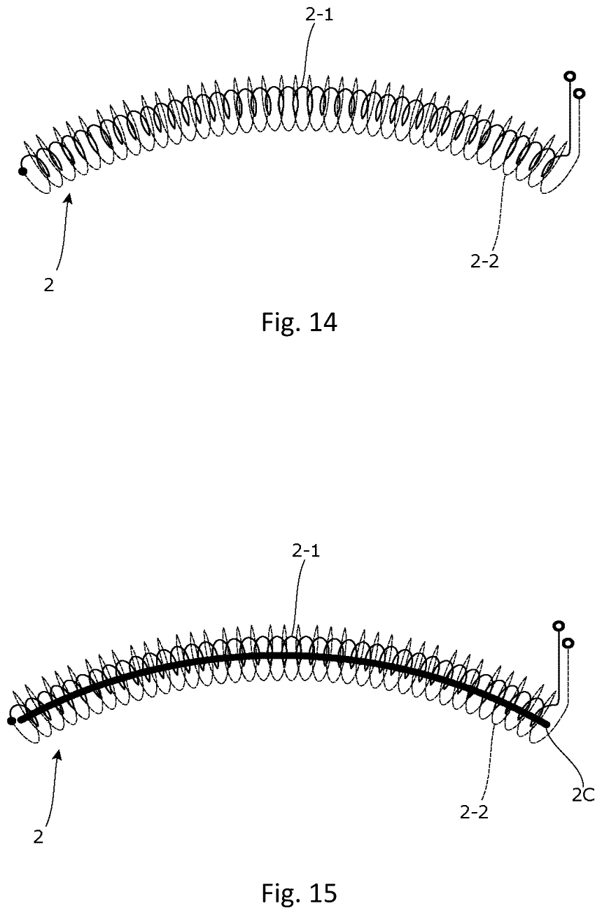

FIG. 14 is a front view that shows an example of a vector potential coil 2 in a moving body device (for instance, the above-mentioned vehicle 101 and train 302) according to a sixth embodiment.

In the sixth embodiment, as shown in, for instance, FIG. 14, the VP coil 2 has an inner solenoid coil 2-1 and an outer solenoid coil 2-2 that have the same coil axis each other but have different coil diameters from each other. Further, one coil end of the inner solenoid coil 2-1 and one coil end of the outer solenoid coil 2-2 are electrically connected. The inner solenoid coil 2-1 and the outer solenoid coil 2-2 respectively works as one VP coil. Therefore, the VP coil 2 in the sixth embodiment electrically has a configuration in which two VP coils are connected in series and in the same phase. Further, the inner solenoid coil 2-1 and the outer solenoid coil 2-2 are wound and connected each other so that a vector potential and a magnetic field being generated by the inner solenoid coil 2-1 and a vector potential and a magnetic field being generated by the outer solenoid coil 2-2 are respectively in the same direction.

Therefore, since two wirings, which are from the other coil end of the inner solenoid coil 2-1 and from the other coil end of the outer solenoid coil 2-2 to the power supply device 6, can be laid together, the laying of the two wirings can be simplified.

Note that the other configurations and operations of the moving body device according to the sixth embodiment are the same as those explained in any of the first to the third embodiments. Therefore, the explanations of them will be omitted.

### Seventh Embodiment

FIG. 15 is a front view that shows an example of a vector potential coil 2 and a ferromagnetic member 2C in a moving body device (for instance, the above-mentioned vehicle 101 and train 302) according to a seventh embodiment.

In the seventh embodiment, as shown in, for instance, FIG. 15, the VP coil 2 has the inner solenoid coil 2-1 and the outer solenoid coil 2-2 in the same manner as the sixth embodiment. Further, in the seventh embodiment, as shown in, for instance, FIG. 15, a ferromagnetic member 2C is arranged inside the VP coil 2 (the inner solenoid coil 2-1). This ferromagnetic member 2C is the same as the above-mentioned ferromagnetic member 2A. However, the VP coil 2 and the ferromagnetic member 2C are not electrically connected. Further, the ferromagnetic member 2C may not have to be conductive.

Note that the other configurations and operations of the moving body device according to the seventh embodiment are the same as those explained in the sixth embodiment. Therefore, the explanations of them will be omitted.

### Eighth Embodiment

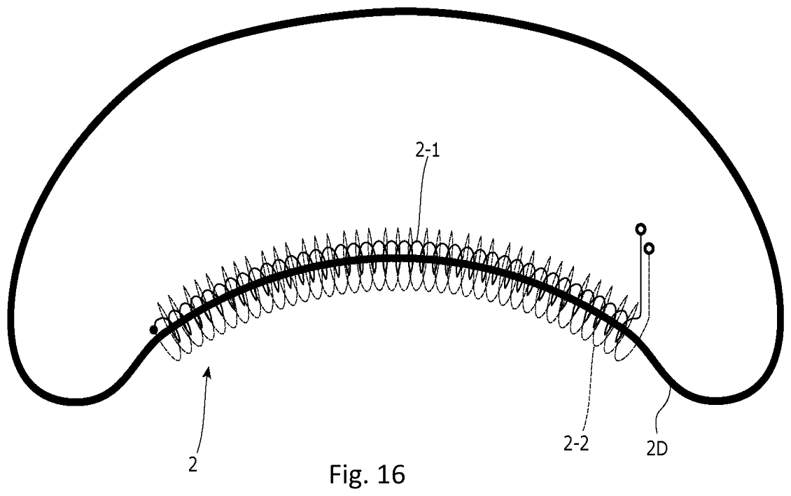

FIG. 16 is a front view that shows an example of a vector potential coil 2 and a ferromagnetic member 2D in a moving body device (for instance, the above-mentioned vehicle 101 and train 302) according to an eighth embodiment.

In the eighth embodiment, as shown in, for instance, FIG. 16, the VP coil 2 has the inner solenoid coil 2-1 and the outer solenoid coil 2-2 in the same manner as the sixth and seventh embodiments. Further, in the eighth embodiment, as shown in, for instance, FIG. 16, a ferromagnetic member 2D is arranged inside the VP coil 2 (the inner solenoid coil 2-1). The ferromagnetic member 2D is in a shape along a coil axis of the VP coil 2. In addition, the ferromagnetic member 2D extends toward an outside of a curvature of the VP coil 2 (a coil axis portion of the VP coil 2) so as to form a closed magnetic path. Further, the VP coil 2 and the ferromagnetic member 2D are not electrically connected. There is no need to provide a gap as mentioned above. Furthermore, the ferromagnetic member 2D may not have to be conductive.

Note that the other configurations and operations of the moving body device according to the eighth embodiment are the same as those explained in the seventh embodiment. Therefore, the explanations of them will be omitted.

### Ninth Embodiment

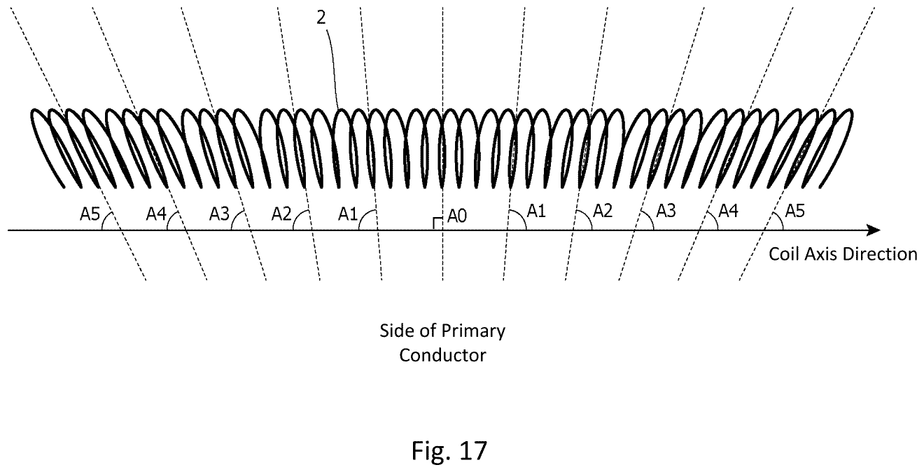

FIG. 17 is a front view that shows an example of a vector potential coil 2 in a moving body device (for instance, the above-mentioned vehicle 101 and train 302) according to a ninth embodiment.

In the ninth embodiment, as shown in, for instance, FIG. 17, the VP coil 2 is wound along (around) a linear coil axis. But, the VP coil 2 is wound so that inclination angles A0-A5 in the winding direction (an angle between the coil axis direction and the winding direction) gradually change along the direction of the coil axis. Specifically, the inclination angle at the center of the VP coil 2 is 90 degrees. Further, the inclination angle becomes smaller as it moves away from the center (A0>A1>A2>A3>A4>A5). As a result, the above-mentioned vector potential can be efficiently sensed in the same manner as the case of the curved VP coil 2.

Note that the other configurations and operations of the moving body device according to the ninth embodiment are the same as those explained in any of the first to the third embodiments. Therefore, the explanations of them will be omitted.

### Tenth Embodiment

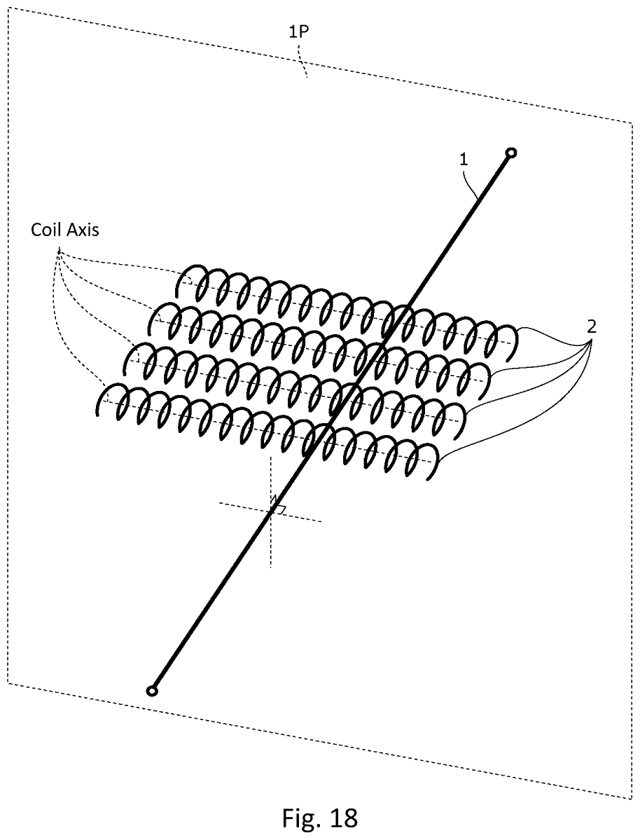

FIG. 18 is a top view that shows an example of a vector potential coil 2 in a moving body device (for instance, the above-mentioned vehicle 101 and train 302) according to a tenth embodiment.

In the tenth embodiment, as shown in, for instance, FIG. 18, the VP coil 2 is wound along a linear coil axis. Further, in this embodiment, a plurality of VP coils 2 are arranged. The plurality of VP coils 2 are electrically connected in series or in parallel to one another. Furthermore, (for instance, as explained below) the power supply device 6 may have a plurality of AC/DC converter circuits for the plurality of VP coils 2, respectively. Further, outputs of the plurality of AC/DC converter circuits may be connected in series or in parallel. In addition, the outputs that are connected in serial or in parallel may be used to supply power to a capacitor for storing electricity or the above-mentioned electronic devices. Further, in FIG. 18, four of the VP coils 2 are provided. However, the number of VP coils 2 may be any of one to three, or five or more.

Here, each of the VP coils 2 is arranged so that the coil axis extends on a vertical plane 1P perpendicular to a primary conductor (for instance, the primary conductor 1 or the overhead wire 301). Further, the plurality of VP coils 2 are arranged along the direction of the primary conductor. In other words, the plurality of VP coils 2 are arranged so that the coil axes of the plurality of VP coils 2 are contained on a single plane.

Note that the other configurations and operations of the moving body device according to the tenth embodiment are the same as those explained in any of the first to the third embodiments. Therefore, the explanations of them will be omitted.

### Eleventh Embodiment

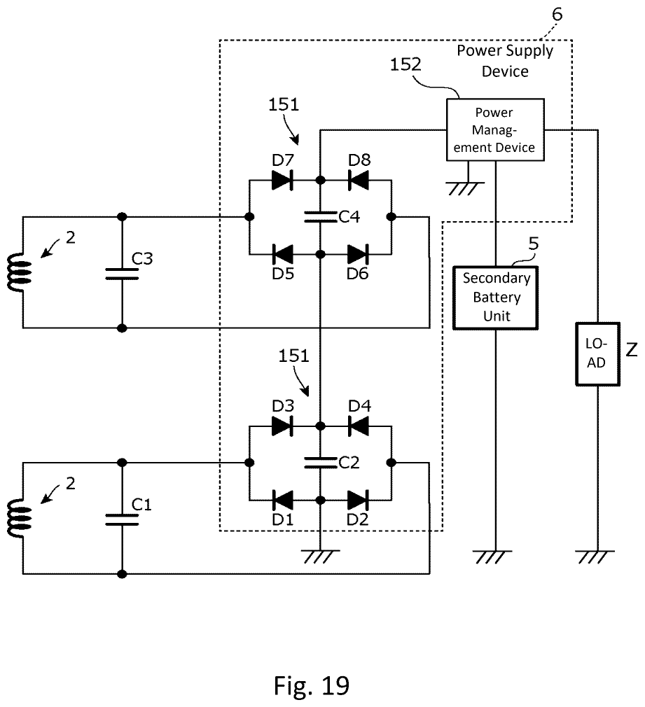

FIG. 19 is a circuit diagram that explains a resonant circuit in a moving body device (for instance, the above-mentioned vehicle 101 and train 302) according to an eleventh embodiment.

As shown in, for instance, FIG. 19, in the moving body device (for instance, the vehicle 101 or the train 302) according to the eleventh embodiment, capacitors C1 and C3 are connected in parallel to the VP coils 2. Further, each of the capacitors C1 and C3 is provided for each of the VP coils 2. Thus, in FIG. 19, two of the capacitors C1 and C3 are respectively connected to two of the VP coils 2.

Furthermore, the power supply device 6 shown in FIG. 19 includes, for each of the VP coils 2, as an AC/DC converter circuit 151, a full-wave rectifying circuit (a diode bridge of diodes D1-D4 and a diode bridge of diodes D5-D6) and a smoothing capacitor C2, C4. Further, outputs of the full-wave rectifying circuits and the smoothing capacitors C2 and C4 of two of the VP coils 2 are connected in series so as to form the output of the power supply device 6. An output voltage of the power supply device 6 is applied to, for instance, the secondary battery unit 5 and a load Z (for instance, the motor 3 and the internal device 4). Note that in this embodiment, there are two VP coils 2. However, there may be one or three or more. Further, the more stages being connected in series, the higher the voltage that can be obtained. Furthermore, outputs of these AC/DC converter circuits 151 may be connected in parallel. In that case, a large current can be obtained. Moreover, the above-mentioned full-wave rectifying circuit may be an active FET bridge that operates even at a lower voltage.

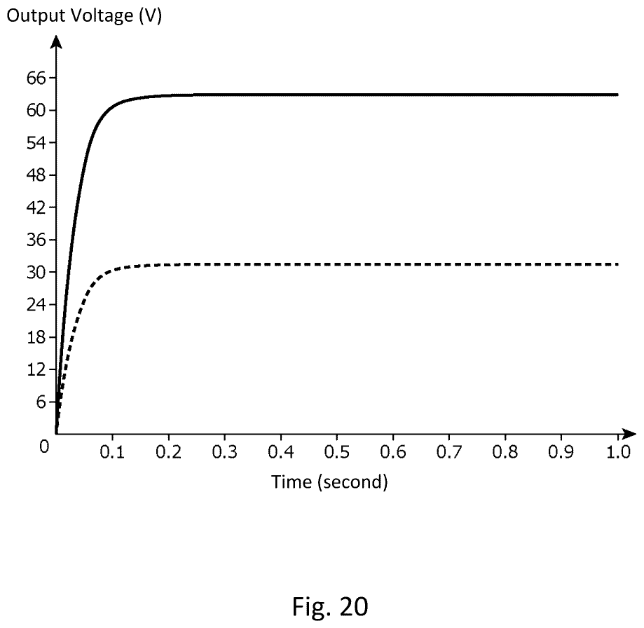

Here, a simulation result of an output voltage will be explained. FIG. 20 is a diagram that shows the simulation result of the output voltage of the power supply device 6 with respect to the eleventh embodiment. FIG. 20 shows the simulation result of the output voltage with respect to a case in which a coupling coefficient between a primary conductor and a VP coil is 0.1, a self-inductance L00 (=μ0×Len/8π) of the primary conductor (a linear conductor) having a length Len is 5 uH, and a frequency of the AC current in the primary conductor is 1 kHz. The broken line in FIG. 20 indicates the time transition of a first stage voltage (a voltage at the connection point between diodes D and D4 and diodes D5 and D6). Further, the solid line in FIG. 20 indicates the time transition of the output voltage of power supply device 6 (i.e., a second stage voltage). As shown in FIG. 20, it is understood that a DC output voltage according to the number of stages can be obtained.

Note that the other configurations and operations of the moving body device according to the eleventh embodiment are the same as those explained in any of the first to the tenth embodiments. Therefore, the explanations of them will be omitted.

As mentioned above, in the eleventh embodiment, the resonant circuit including the VP coils 2, which has the same resonant frequency as the frequency of the AC current in the primary conductor, is provided. Thus, the AC current being conducted to the VP coils 2 is increased.

Note that various changes and modifications to the embodiments described above will be apparent to one having ordinally skill in the art. Such the changes and modifications may be made without departing from the spirit and scope of the subject matter and without diminishing the intended advantages. That is, it is intended that such the changes and modifications are included within the scope of the claims.

For instance, in the above-mentioned embodiments, one or a plurality of VP coils 2 are arranged at one of the front and rear gable walls of the train 302. However, one or the plurality of VP coils 2 may be arranged at both of the front and rear gable walls of the train 302.

Further, in the above-mentioned embodiments, the body of the moving body device may be configured with aluminum or FRP (Fiber Reinforced Plastics). Further, in the case in which the body of the moving body device is configured with the FRP, the VP coil 2 may be embedded in the body and be integrally formed with the body.

In addition, in the above-mentioned embodiments, the VP coil 2 may be designed to sense a change in a magnetic flux density due to an AC current in the primary conductor so as to induce an AC current.

In addition, in the above-mentioned embodiments, the VP coil 2 is arranged at the gable wall or the roof. However, the VP coil 2 may be arranged at the floor instead. For instance, in the case in which the primary conductor is laid at a side of the rail, the VP coil 2 may be arranged at the floor so that the primary conductor is arranged to be located at the inner side of the curvature of the VP coil 2.

In addition, in the above-mentioned sixth to eighth embodiments, the VP coil 2 has a two-layer structure, which are the inner solenoid coil 2-1 and the outer solenoid coil 2-2, in the radial direction. However, the number of layers may be four or more as long as the number of layers is an even number. In this case, either end of the ends of the solenoid coil 2-i is connected to the solenoid coil 2-(i+1) in the next layer so that the solenoid coils 2-i in all layers are electrically connected in series.

In addition, in the above-mentioned embodiments, the frequency of the AC current may be 50 Hz or 60 Hz that is the same as that of the commercial power supply or may be a frequency being higher than that of the commercial power supply (for instance, any of 100 Hz-1 kHz, or any of 1 kHz-10 kHz). In the case in which the power distribution device 1A supplies an AC current of a frequency being higher than that of the commercial power supply, a power plant of that frequency may be built and AC power of that frequency may be supplied to the power distribution device 1A. Alternatively, a frequency conversion may be performed on the AC power of the commercial power supply and AC power of that frequency may be supplied to the power distribution device 1A.

In addition, in the above-mentioned embodiments, the above-mentioned primary conductor may be arranged below or above the passing moving body device on the moving path or may be arranged to the side of the passing moving body device. The VP coil 2 is arranged at the moving body device so as to be adjacent to the primary conductor according to the arrangement position of the primary conductor. Further, in the case in which the VP coil 2 has a curved coil axis, the VP coil 2 is arranged so that the primary conductor is arranged at the inner side of the curvature.

In addition, in the above-mentioned embodiments, the above-mentioned locomotives and electric trains 302 are various kinds of railway vehicles. Further, the above-mentioned locomotives and electric trains 302 include not only those that move on a set of rails but also monorail vehicles, guide-rail system railway vehicles that move along a guide rail(s) via rubber-tired wheels on a specific path, and magnetic levitation system railway vehicles.

In addition, in the above-mentioned embodiments, one primary conductor 1 is laid for one moving path (such as a lane). However, a plurality of primary conductors 1 may be laid for one moving path (such as a lane) instead.

### INDUSTRIAL APPLICABILITY

The present invention can be applicable to, for instance, a moving body device such as an electric vehicle.

1. A moving body power supply system comprising:
a primary conductor through which an alternating current flows; and
a moving body device having a vector potential coil, the vector potential coil sensing a vector potential in a contactless manner generated by the alternating current flowing in the primary conductor, the vector potential coil conducting a current generated from a voltage difference due to the vector potential,
wherein the primary conductor is a part or an entirety of a conductor wire that is continuously arranged along a moving path of the moving body device, and
the vector potential coil continuously senses the vector potential in the contactless manner and conducts the current when the moving body device is on the moving path.

2. The moving body power supply system according to claim 1,
wherein the moving body device is a vehicle,
the moving path is a road, and
the primary conductor is in a linear shape or a curved shape according to a shape of the road.

3. The moving body power supply system according to claim 2,
wherein the road has a plurality of lanes,
the primary conductor is respectively arranged at the plurality of lanes in parallel to one another,
the alternating current respectively flows in the primary conductor in the plurality of lanes in a forward direction or a reverse direction, and
a sum of the alternating current flowing in the forward direction and a sum of the alternating current flowing in the reverse direction are substantially zero at each point of time.

4. The moving body power supply system according to claim 2,
wherein the moving path includes one or a plurality of parking spaces for the vehicle in a parking lot.

5. The moving body power supply system according to claim 2,
wherein the primary conductor is in a shape in which the alternating current is conducted in a meandering manner.

6. The moving body power supply system according to claim 1,
wherein the moving body device is a locomotive engine or a train,
the moving path is a track, and
the primary conductor is in a linear shape or a curved shape according to a shape of the track.

7. A moving body device comprising:
a vector potential coil, the vector potential coil sensing a vector potential in a contactless manner generated by an alternating current flowing in a primary conductor, the primary conductor being a part or an entirety of a conductor wire that is continuously arranged along a moving path of the moving body device, the vector potential coil conducting a current generated from a voltage difference due to the vector potential,
wherein the vector potential coil continuously senses the vector potential in the contactless manner and conducts the current when the moving body device is on the moving path.

8. The moving body device according to claim 7,
wherein the moving body device is a vehicle,
the primary conductor is embedded in the road, and
the vector potential coil is arranged at a bottom of a chassis or a body of the vehicle.

9. The moving body device according to claim 7,
wherein the moving body device is a vehicle,
the primary conductor is embedded in the road,
the vehicle has a secondary battery unit,
the secondary battery unit is arranged at a bottom of a chassis or a body of the vehicle, and
the vector potential coil is arranged on at least an upper surface of the secondary battery unit.

10. The moving body device according to claim 7,
wherein the moving body device is a vehicle,
the primary conductor is embedded in the road,
the vehicle has a secondary battery unit,
the secondary battery unit is arranged at a bottom of a chassis or a body of the vehicle, and
the vector potential coil is arranged within a thickness of a wall of a case of the secondary battery unit.

11. The moving body device according to claim 7,
wherein the moving body device is composed of a member having a magnetic shielding property, and
the vector potential coil is arranged at an inside of the moving body device.

12. The moving body device according to claim 7,
wherein the vector potential coil is a solenoid coil extending along a curved coil axis, and
the primary conductor is arranged so as to be located at an inner side of the curvature.

13. The moving body device according to claim 12, further comprising:
a ferromagnetic member arranged at an inside of the vector potential coil, the ferromagnetic member being in a shape along a coil axis of the vector potential coil.

14. The moving body device according to claim 13,
wherein the ferromagnetic member extends toward an outside of the curvature to form a closed magnetic path.

15. The moving body device according to claim 7,
wherein the vector potential coil has an inner solenoid coil and an outer solenoid coil that have the same coil axis each other but have different coil diameters from each other, and
one coil end of the inner solenoid coil and one coil end of the outer solenoid coil are electrically connected.

16. The moving body device according to claim 15, further comprising:
a ferromagnetic member arranged at an inside of the inner solenoid coil, the ferromagnetic member being in a shape along the coil axis.

17. The moving body device according to claim 7,
wherein the vector potential coil is wound around a linear coil axis so that an inclination angle in a winding direction gradually changes along a direction of the coil axis.

18. The moving body device according to claim 7, further comprising:
a capacitor that configures a resonant circuit together with the vector potential coil.
